(19) United States
(12) Patent Application Publication
(10) Pub. No.: US 2010/0131152 A1
(43) Pub. Date: May 27, 2010

(54) System, device and method for automatically stopping and starting engines of motor vehicles

(76) Inventors: Sylvain Castonguay, Ste-Marthe-sur-le-Lac (CA); Frederick Prigge, Montreal (CA)

Correspondence Address: BCF LLP, 1100 RENE'-LE'VESQUE BLVD. WEST, 25TH FLOOR, MONTREAL, QC, H3B-5C9, CA

(21) Appl. No.: 12/585,158

(22) Filed: Sep. 4, 2009

Related U.S. Application Data
(60) Provisional application No. 61/136,442, filed on Sep. 5, 2008.

(51) Int. Cl. F02D 45/00; B60H 1/04; B60L 7/18

(52) U.S. Cl. 701/36; 237/12.3 R; 701/112; 701/113

(57) ABSTRACT

Systems, control methods and related apparatus for engine idling reduction, to decrease operating cost and pollution related to the use of an automotive vehicle, while increasing its autonomy. Integrated are an automatic start-stop device, an increased onboard energy capacity, an electric pump that circulates engine coolant to the heater radiator to extract engine thermal inertia for cabin heating and an engine electric cooling system. The system is designed to reduce fuel consumption and air pollution while maintaining auxiliary systems in function and the cabin temperature at an acceptable level when the engine is stopped. This system may be integrated aboard internal combustion engine vehicles that have important idling periods in normal conditions. Such systems can either be implemented as retrofit kits or during a vehicle's manufacturing, directly by the original equipment manufacturer (OEM).

### CROSS REFERENCE TO RELATED APPLICATIONS

This Application claims priority on U.S. Provisional Application No. 61/136,442, filed on Sep. 5, 2008, which is herein incorporated by reference.

### FIELD OF THE INVENTION

The present invention relates to systems, devices and control methods to increase the autonomy and decrease the operating costs and pollution related to the use of automotive vehicles having an internal combustion engine.

### BACKGROUND OF THE INVENTION

Anti-idling devices are used in the automotive industry to reduce fuel consumption and reduce Green House Gases (GHG) emissions. Start-stop devices have been developed to reduce fuel consumption for vehicles waiting for traffic signals to change. Hybrid vehicles are also anti-idle compatible or may even run using only electric power.

Internal combustion engines (ICE) have low efficiency, typically around 30%, and heavy bulk weight. Advantages are taken of those conditions, to provide heating facilities inside the cabin by extracting heat from the motor block. Such techniques are already used by manufacturers of hybrid vehicles, but are not yet used on conventional drive trains.

Soft hybrids or micro-hybrids are manufactured to produce low cost energy efficiency on the drive rains and may reduce fuel consumption by up to 15% in urban mode. It is unfortunate to notice that the penetration of these new configurations is very slow, even today; manufacturers of such configurations are limiting the technology to a few models.

While many manufacturers are oriented to new technologies and advanced hybrid power trains, it remains useful to implement new technologies that can be retrofitted into existing fleets or into new conventional vehicles.

Therefore, there is a need in the automotive art for further fuel-saving systems and devices.

### SUMMARY OF THE INVENTION

The present invention is directed to a system and a method for providing idle start-stop control to an internal combustion engine vehicle while maintaining enough electric power to keep the auxiliary systems functional and the cabin's ambient temperature at a certain level of comfort during standby conditions.

The invention relates to a dual purpose electrical energy storage that can support deep discharges and maintain enough cranking power to start an engine. This storage could be a single or a combination of two or more batteries. In the latter case, the batteries will typically be of the same type. Therefore, it is not necessary to rely on the alternator powered by the engine to maintain the auxiliary systems of the vehicle operative, thereby increasing periods where idling may be avoided.

In accordance with another aspect of the present invention, a method for heating the cabin using the engine's thermal inertia, when the engine is turned off, is proposed. An electrical pump is used to move the engine coolant between the engine bloc and the heater core. The pump is activated when the vehicle is being shut down if heating is required based on a sensor reading through the CAN bus or any other means. Since all auxiliary systems are still powered by the battery, the heating system should be capable of working for a relatively long period without starting the engine.

In other embodiments according to the present invention, methods for controlling engine start or engine shut down sequences use common sequences and predetermined conditions to run either sequence. Start conditions include vehicle rest, low limit battery voltage, and engine coolant temperature below a user selected temperature. Low limit battery voltage may be programmed to change as a function of outside temperature.

Stop conditions include vehicle rest, transmission in “parking” or “neutral” positions, engine coolant temperature range over 85° C., or so. If battery low voltage has conditioned the engine to restart, the device must then operate over a predetermined period.

The method also prevents the device from starting or stopping the engine if some conditions are not met, in order to prevent the cycles to start-stop the engine for very short periods. Once started, the engine could only be turned off after a delay of at least sixty (60) seconds, if all shut down conditions are met.

More specifically, in accordance with the present invention, there is provided an internal combustion engine (ICE) vehicle having a no-idle system, comprising a dual purpose electrical energy storage, a cabin heating system using the engine thermal inertia.

Also in accordance with the present invention, there is provided a system for selectively stopping and starting the internal combustion engine (ICE) of a vehicle during idling periods thereof, comprising a dual purpose electrical energy storage, and a cabin heating system using the engine thermal inertia.

Other objects, advantages and features of the present invention will become more apparent upon reading of the following non-restrictive description of embodiments thereof, given by way of example only with reference to the accompanying drawings.

### BRIEF DESCRIPTION OF THE DRAWINGS

Reference will now be made to the accompanying drawings, showing by way of illustration an illustrative embodiment of the present invention, and in which:

FIG. 1 is a schematic view of a system for automatically stopping and starting engines of motor vehicles in accordance with an embodiment of the present invention;

FIG. 2 is a block diagram illustrating the operation of a system or a method for controlling an internal combustion engine while providing electricity for auxiliary equipment and heat to the cabin;

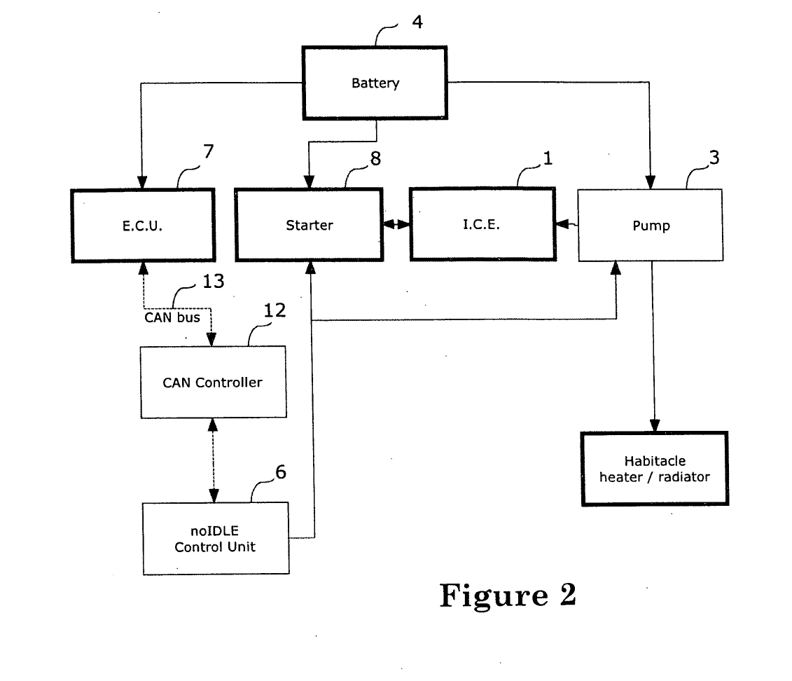

FIG. 3A is a schematic view illustrating a fluid path when the engine is shut down; and

FIG. 3B is a schematic view illustrating a fluid path when the engine is running normally.

### DESCRIPTION OF ILLUSTRATIVE EMBODIMENTS OF THE INVENTION

The present invention generally relates to the integration of automatic engine start-stop systems combined with a heating and ventilating system using an electric pump (that circulates engine coolant to the heater core to extract engine thermal inertia for cabin heating, when the engine is not running), an electric engine cooling system, an extended electrical energy storage and a regenerative braking.

Although the present invention can be installed in the factory when new vehicles are assembled, it also delivers an aftermarket system that can increase overall mileage, and/or reduce significantly motor wear, fuel consumption and the emission of pollutants such as GHG, by reducing vehicle motor idling of conventional (i.e. non-hybrid) vehicles while providing additional onboard energy storage.

Measurements have shown that for some vehicles, idling times may reach up to 20%. Giving this number and considering the great number of existing conventional vehicles and new conventional vehicles being manufactures, the system of the present invention brings a solution to a growing problem.

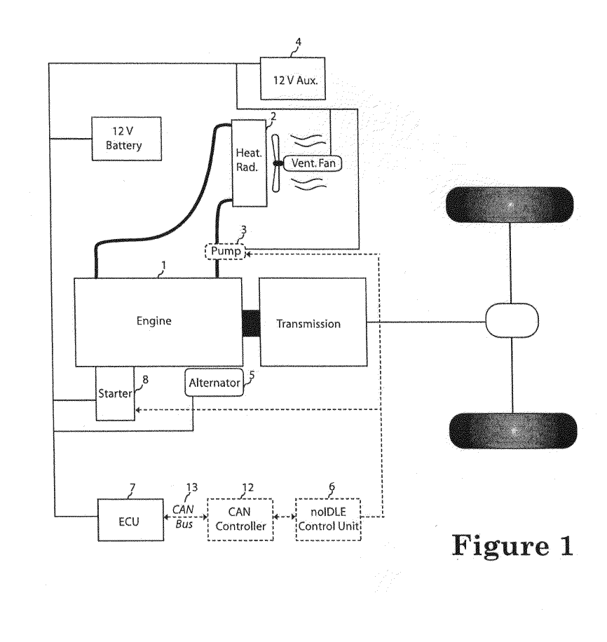

Now turning to the figures of the appended drawings, the embodiment of the present invention shown in FIG. 1 comprises an electrically activated heating and venting system, using engine thermal inertia to provide heat, an auxiliary electric pump to circulate the engine coolant, a dual purpose battery and an electronic customizable start stop device.

The present invention uses the thermal inertia of an engine 1 to heat and keep warm a heater core 2 when the engine is not running. An auxiliary electrical pump 3 is used to circulate the coolant. This allows the vehicle's cabin to be kept warm.

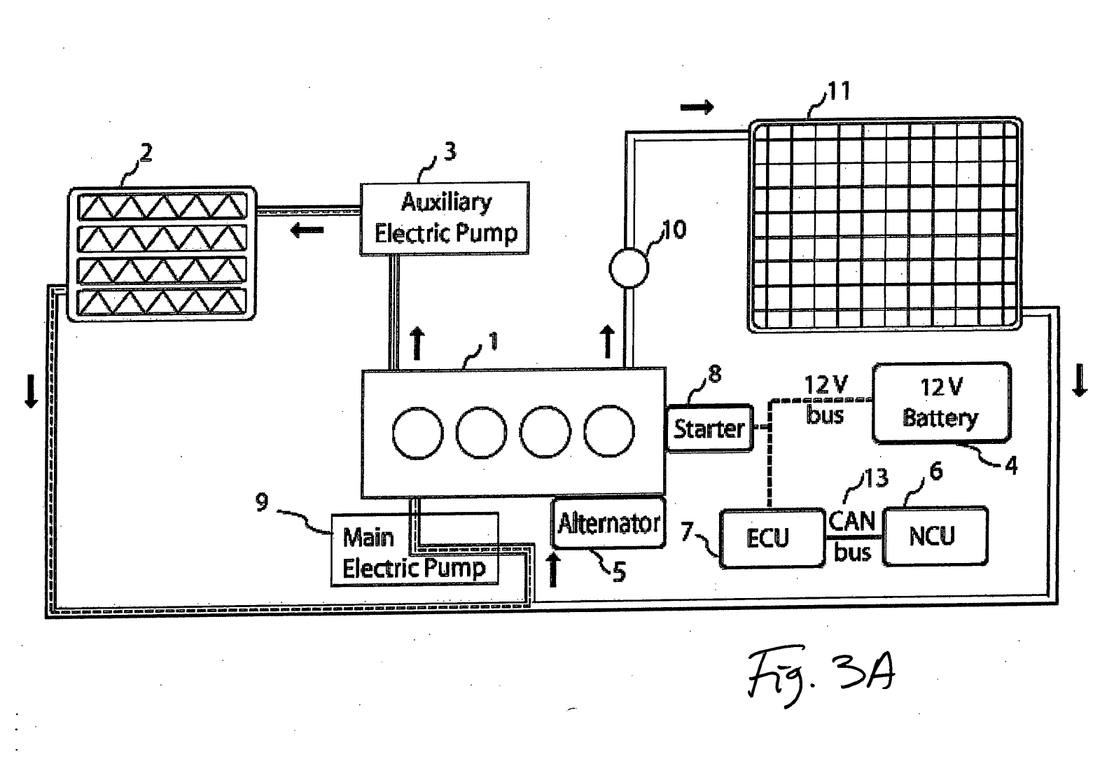

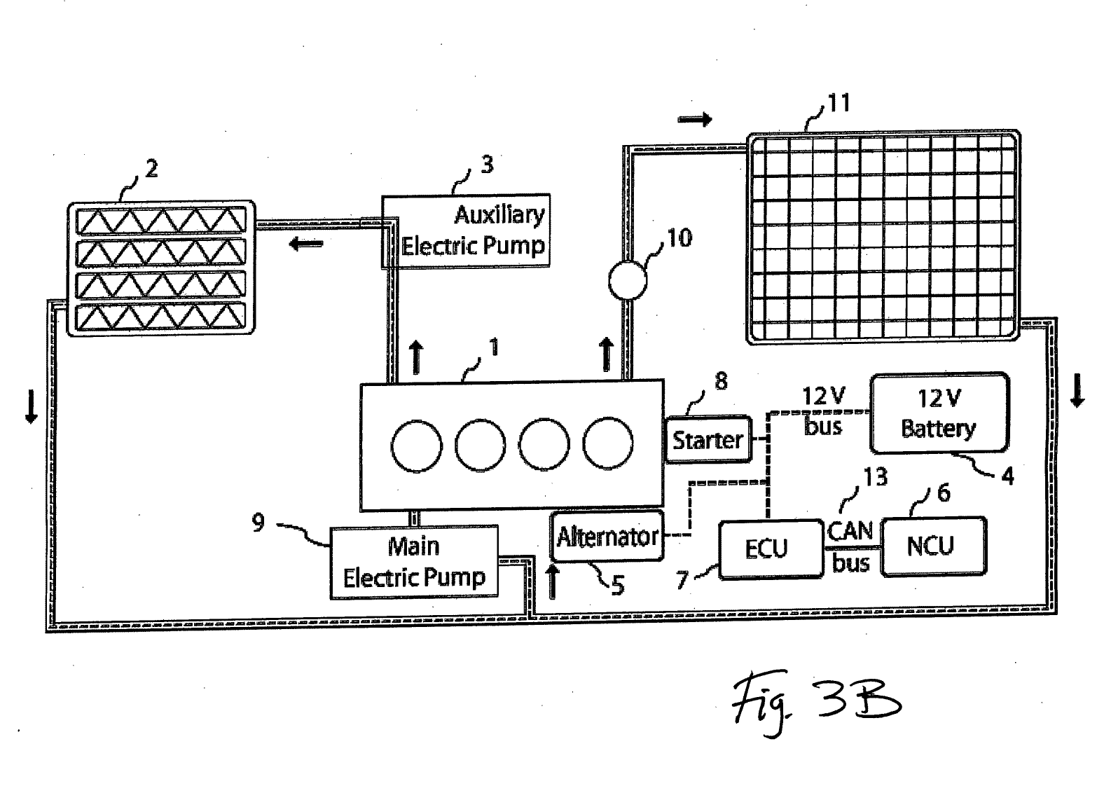

FIG. 3A shows the path of the heating flow when the engine is not running. It may be noticed that the main coolant pump is not activated but allows the flow to circulate from the engine to the heater core.

To ensure enough electric energy is stored onboard the vehicle when the engine 1 is not running, a special dual purpose electrical energy storage 4 is provided. This increases the period where no electricity will be produced onboard by the vehicle's alternator 5, while maintaining the 12V auxiliary systems in operation.

A no-idling control unit 6 (NCU), which is used to condition the engine start and stop sequence, is connected to the vehicle's electronic control unit 7 (ECU) via the bus 12 of the vehicle's Controller Area Network (CAN) 13. When requested by a low coolant temperature or battery voltage, the NCU 6 activates the ECU 7 and the vehicle's starter 8 to restart the engine 1.

FIG. 3B illustrates the heat flow when the engine 1 is running at any speed, including idling. In FIG. 3, the auxiliary electrical pump 3, used when the engine 1 is not running, allows the flow to go through without offering resistance.

When the engine 1 is running, an electronic thermal management system is used to optimize motor temperature and efficiency. Another electrical pump 9 may be used to replace the conventional water pump. An electrically activated valve 10 may be used to replace the conventional mechanical thermostat that provides resistance to the coolant flow. This system circulates the coolant to the vehicle's radiator 11.

When the engine 1 is running and the vehicle is braking, a regenerative braking system consisting of an increased charge on the alternator 5 is used to create regenerative braking. The additional energy is sent to the electrical energy storage system 4. The energy is then made available for the 12 V auxiliary systems, once the engine 1 is shut down.

From the foregoing, it should now be apparent that the system and method of the present invention allow to better offset the disadvantages of an idling engine by controllably shutting down and restarting the engine so as to reduce the idling periods thereof while continuing to provide energy to run 12V auxiliary systems even once the engine has been turned off by the present system.

Although the present invention has been described hereinabove by way of embodiments thereof, it may be modified, without departing from the nature and teachings of the subject invention as described herein.

What is claimed is:

1. An internal combustion engine (ICE) vehicle having a no-idle system, comprising a dual purpose electrical energy storage, a cabin heating system using the engine thermal inertia.

2. An ICE vehicle as defined in claim 1, further comprising a bloc heating controller with a variable speed electric motor.

3. An ICE vehicle as defined in claim 1, further comprising a regenerative braking system.

4. An ICE vehicle as defined in claim 2, wherein the bloc heating controller is provided with a regenerative braking system.

5. A system for selectively stopping and starting the internal combustion engine (ICE) of a vehicle during idling periods thereof, comprising a dual purpose electrical energy storage, and a cabin heating system using the engine thermal inertia.

6. A system as defined in claim 5, further comprising a bloc heating controller with a variable speed electric motor.

7. A system as defined in claim 5, further comprising a regenerative braking system.

8. A system as defined in claim 6, wherein the bloc heating controller is provided with a regenerative braking system.
